(19) United States
(12) Patent Application Publication
(10) Pub. No.: US 2013/0238397 A1
(43) Pub. Date: Sep. 12, 2013

(54) Data Processing Based on Online Transaction Platform

(71) Applicant: Qing Lei, Hangzhou (CN)

(72) Inventor: Qing Lei, Hangzhou (CN)

(73) Assignee: ALIBABA GROUP HOLDING LIMITED, Grand Cayman (KY)

(21) Appl. No.: 13/393,276

(22) PCT Filed: Oct. 31, 2011
(86) PCT No.: PCT/US11/58612

§ 371 Date: Feb. 29, 2012

(30) Foreign Application Priority Data
Nov. 4, 2010 (CN) 201010533004.8

(51) Int. Cl. G06Q 30/02

(52) U.S. Cl. CPC G06Q 30/0206
USPC 705/7.33

(57) ABSTRACT

An online transaction platform implements searching for product information from a database according to category information. The products are categorized based on product attributes and sale attributes to obtain multiple product categories. The products under the same product category have same or substantially similar product attributes and sale attributes. One or more calculation algorithms may be applied to the products under each category respectively to calculate price information that corresponds to each product category. The price information refers to price information of the products under their corresponding sale attributes. The price information of the corresponding product category is displayed when a product keyword corresponding to the product category is received. The method and device described herein may improve the operation speed and performance of servers for the online transaction platform.

### CROSS REFERENCE TO RELATED PATENT APPLICATIONS

This application is a national stage application of an international patent application PCT/US11/58612, filed Oct. 31, 2011, which claims priority from Chinese Patent Application No. 201010533004.8 filed on Nov. 4, 2010, entitled “Method and Apparatus for Data Processing Based on Online Transaction Platform,” which applications are hereby incorporated by reference in their entirety.

### TECHNICAL FIELD

The present disclosure relates to the field of network data processing technology, more specifically, to a data processing method and a device based on an online transaction platform.

### BACKGROUND

The online transaction platform needs to ensure the security and authenticity of both buyers and sellers in transactions via the Internet. The websites used in the online transaction platform are known as e-commerce websites. In actual application scenarios, when users want to buy products from the e-commerce websites, they pay a lot of attention to the price information of the products. Vertical websites refer to websites focusing on specific fields (for example, shopping) or specific requirements, and provide comprehensive and in-depth information and services that are related to the specific fields or specific requirements.

Presently, in the Internet, when there is a need to know the price information of a product in the online transaction platform, the price information is usually obtained from the vertical websites. But the price information in the vertical websites is usually retrieved in the following manners: calculation from the offline market transactions; labeled price information directly from the manufacturers of the product; and a quote directly from a user who sells the product. But in the real world, it is possible that the manufacturers' labeled price information deviates from the market price, or a certain user's quote does not necessarily represent the price information of the majority of users, and does not reflect the market conditions. In addition, the vertical websites are difficult to provide the price information of products that are not traded at the online transaction platform.

The present technologies, based on the product price information provided by the vertical websites, may not provide sufficiently accurate price information, and thus may not satisfy the user's requirement of accurate price information in the online transaction platform and, at the same time, may increase the frequency and the time that the users spend in searching for the price information. This will further decrease the processing speed and performance of the server(s) in the online transaction platform.

In summary, people skilled in this field are facing the challenge of providing a data processing method based on the internet transaction platform to solve the user's unsatisfied need of data accuracy at the online transaction platform without negatively impacting the server's processing speed and performance.

### SUMMARY

The present disclosure provides a data processing method based on the online transaction platform to solve the user's unsatisfied need of data accuracy at the online transaction platform without negatively impacting the server's processing speed and performance.

In addition, the present disclosure also provides a data processing device.

In the data processing method, product information under a category is searched from a database according to category information. The product information includes product identification (ID) and product price information.

The products are categorized based on the product attributes and sale attributes to obtain multiple product categories. The products under the same product category have same or substantially similar product attributes and sale attributes. The sale attributes are attributes other than the product attributes that affect the product prices.

One or more calculation algorithms may be applied to the products under each category respectively to calculate price information that corresponds to each product category. The one or more calculation algorithms include a clustering algorithm. The price information refers to price information of the products under their corresponding sale attributes.

When a product keyword is received, the price information of the product category corresponding to the product keyword is displayed.

The present disclosure also discloses a data processing device based on the online transaction platform. The device includes a search module, a categorization module, a price calculation module, and a display module.

The search module searches product information under a category from a database according to category information. The product information includes product identification (ID) and product price information.

The categorization module categorizes the products based on the product attributes and sale attributes to obtain multiple product categories. The products under the same product category have same or substantially similar product attributes and sale attributes. The sale attributes are attributes other than the product attributes that affect the product prices.

The price calculation module applies one or more calculation algorithms to the products under each category respectively to obtain price information that corresponds to each product category. The one or more calculation algorithms include a clustering algorithm. The price information refers to price information of the products under their corresponding sale attributes.

The display module displays the price information of a corresponding product category when a product keyword is received.

In comparison to the present technology, the present disclosure has at least the following advantages.

In the present disclosure, the product information under a certain category is searched from the database and the products are categorized according to their product attributes and sale attributes. The products under the same product category have same or substantially similar product attributes and sale attributes. The sale attributes are attributes other than the product attributes that affect the product prices. Thus, the obtained categories also take into consideration the sale attributes that affect the products price information. One or more calculation algorithms such as the clustering algorithm may be applied to the product categories to obtain the average price information of the products. When receiving a user's search query regarding a price of a product, the server of the online transaction platform may return the calculated average price information to the user. The user obtains reasonable and true price information so that the user need not request that the server conduct duplicate or repeated search operations. The method or system running at the server of the online transaction platform also improves the running speed and performance of the server. Certainly, an embodiment under the present disclosure does not need to achieve all of the advantages.

### BRIEF DESCRIPTION OF THE DRAWINGS

To better illustrate embodiments of the present disclosure, the following is a brief introduction of figures to be used in descriptions of the embodiments. It is apparent that the following figures only relate to some embodiments of the present disclosure. A person of ordinary skill in the art can obtain variations of the embodiments in the present disclosure without creative efforts.

FIG. 1 shows a flow diagram of an example data processing method based on an online transaction platform in accordance with a first example embodiment.

FIG. 2 shows an interface schematic diagram of the sales attributes and other fixed properties of an example product “Lenovo I300” in accordance with the first example embodiment.

FIG. 3 shows a flow diagram of applying clustering analysis algorithm to products under a product category to obtain the corresponding price information of each type of products in accordance with the first example embodiment.

FIG. 4 shows an interface schematic diagram of average price information of an example product “Nokia 5230” under two sales attributes that are “Nationwide Guarantee” and “Shop Guarantee” respectively.

FIG. 5 shows a flow diagram of an example data processing method based on an online transaction platform in accordance with a second example embodiment.

FIG. 6, corresponding to FIG. 4, shows a trend diagram of the price information of the example product “Nokia 5230” within the last 3 months.

FIG. 7 shows a flow diagram of exemplary calculating product average price information of products under a second-level product category.

FIG. 8 shows a structured diagram of a first example data processing device based on the online transaction platform in the first example embodiment.

FIG. 9 shows a structured diagram of a price calculation module in the first example data processing device.

FIG. 10 shows a structured diagram of a second example data processing device based on the online transaction platform in the first example embodiment.

### DETAILED DESCRIPTION

To better illustrate embodiments of the present disclosure, the following is a brief introduction of the figures to be used in descriptions of the embodiments. It is apparent that the described embodiments only relate to some instead of all embodiments of the present disclosure. A person of ordinary skill in the art can obtain other embodiments according to the described embodiments in the present disclosure without creative efforts.

The disclosed embodiments may be used in an environment or in a configuration of universal computer systems or specialized computer systems. Examples include a personal computer, a server computer, a handheld device or a portable device, a tablet device, a multi-processor system, a microprocessor-based system, a set-up box, a programmable customer electronic device, a network PC, a small-scale computer, a large-scale computer, and a distributed computing environment including any system or device above.

The present disclosure may be described within a general context of computer-executable instructions executed by a computer, such as a program module. Generally, a program module includes routines, programs, objects, modules, data structure, computer-executable instructions and etc., for executing specific tasks or implementing specific abstract data types. The disclosed method and device may also be implemented in a distributed computing environment. In the distributed computing environment, a task is executed by remote processing devices which are connected through a communication network. In a distributed computing environment, the program module may be located in storage media (which include storage devices) of local and/or remote computers.

In the present disclosure, the product information under a certain category is searched from the database and the products are categorized according to their product attributes and sale attributes. The products under the same product category have same or substantially same product attributes and sale attributes. The sale attributes are attributes other than the product attributes that affect the product prices. Thus, the obtained categories also take into consideration sale attributes that affect the product price information. One or more calculation algorithms such as the clustering algorithm may be applied to the product categories to obtain the average price information of the products. When receiving a user's search query regarding a price of a product, the server of the online transaction platform may return the calculated average price information to the user. The user obtains reasonable and true price information so that the user need not request that the server conduct duplicate or repeated search operations. The method or system of the present disclosure running at the server of the online transaction platform also improves the running speed and performance of the server.

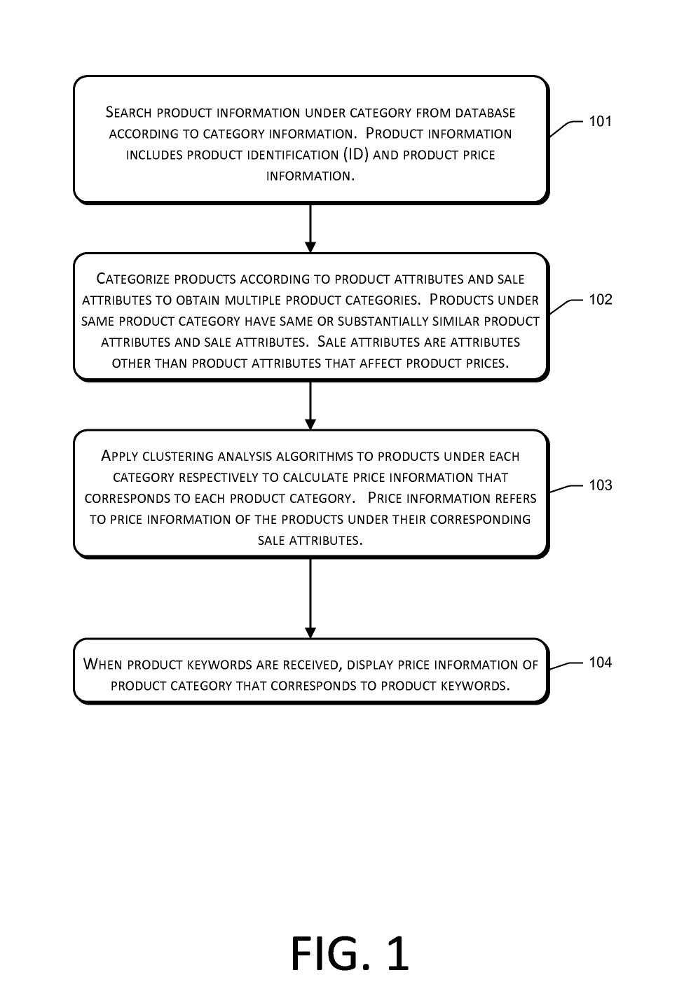

FIG. 1 shows a flow diagram of an example data processing method based on the online transaction platform in a first example embodiment of the present disclosure.

At 101, product information under a category is searched from a database according to category information. The product information includes product identification (ID) and product price information.

In an embodiment, the database may store related transaction information that is involved in the online transaction platform's transactions. Such transaction information may include product information, product transaction information, a seller's information such as the seller's user information at the online transaction platform, etc. The product information may include the product ID and the product price information, and may also include the product seller's ID such as the seller's user ID at the online transaction platform. The product transaction information may include sold price information, information relating to a number of sold products, the seller's user ID, the buyer's user ID. The seller's user information may include the seller's credit information, a 30-day accumulated number of transactions, a number of online products of the seller, information relating to bad rating, and etc. In the example embodiment, the product information may include the product ID and the product price information.

The categories are the industry segment information after categorization of the products. For example, the categories may include mobile phones, notebooks, facial creams, sun block creams, etc. The product, for example, may refer to an item that can be traded at the online transaction platform.

At 102, the products are categorized according to the product attributes and sale attributes to obtain multiple product categories. Products under the same product category have same or substantially same product attributes and sale attributes. The sale attributes are attributes other than the product attributes that affect the product prices.

After the product information under one category is obtained, the corresponding products can be obtained according to the product IDs. The product attribute refers to a fixed attribute of the product that is a fixed functional characteristic of the product.

For example, Nokia N73 is a type of product. Products with a same or substantially same type of Nokia N73 have some of the fixed attributes of Nokia N73. For example, the brand attribute is “Nokia”, the presentation style is “straight-type”, and the camera resolution is “3.2 MP” and etc. Although products with similar functional characteristics are generally considered as under the same product type, the sale prices may differ due to other non-functional attributes such as packaging. In addition to the functional characteristics, the same or substantially same type of product may also have other attributes such as different prices, different package deals, or different after-sales service, and even different levels of newness. All of such attributes are not fixed attributes of the products.

The sale attributes are attributes other than the product attributes that affect the product prices. In other words, the sale attributes are the remaining attributes, after exclusion of the fixed attributes of the products, which may affect the price. For example, one type of cosmetic product may have different kinds of sales packaging, and the capacity of each packaging will cause different sale prices. The other sale attributes such as the after-sale service type and cosmetics volume will also cause different prices.

Therefore, one type of product may be further classified based on the sale attributes. For example, a product such as “Da Bao cosmetic facial wash” has a sale attribute “volume”, and the corresponding values of the sale attribute “volume” may be 300 ml and 100 ml. The sale prices of these two will be different. However, their functional characteristics are actually the same regardless of whether the volume is 300 ml or 100 ml.

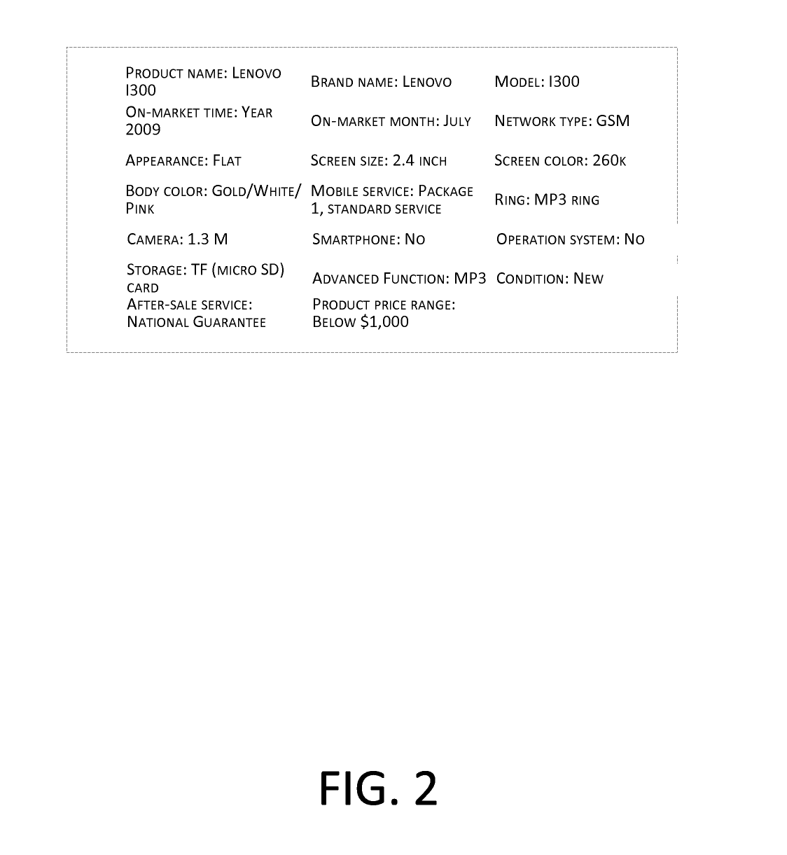

FIG. 2 shows an interface schematic diagram of the sales attributes and the fixed attributes of an example product “Lenovo I300.”

In this example embodiment, the obtained average price is the price of one type of product with same or substantially same product attributes and sale attributes.

At 103, one or more calculation analysis algorithms may be applied to the products under each category respectively to obtain price information that corresponds to each product category. The one or more calculation algorithms include a clustering algorithm. The price information refers to price information of the products under their corresponding sale attributes.

The clustering analysis algorithm may use a K-means algorithm. For example, the clustering analysis algorithm (such as the K-means algorithm) may be used to cluster the product price information to further select a biggest cluster after the clustering. The biggest cluster may be combined with the neighboring clusters until a number of the elements in the combined biggest cluster is greater than a predefined threshold. Then the average price information of the product is obtained according to the price information in the biggest cluster.

The price information obtained in the example embodiment is the corresponding price information of a type of product under its sales attributes. In practical application, even for a same type of product such as the Da Bao facial wash, the sales attributes may not be the same. For example, the sales attribute of one type of product is 100 ml, and the sales attribute of another type of product is 300 ml. Then the price information of these two types of Da Bao facial wash products are not the same.

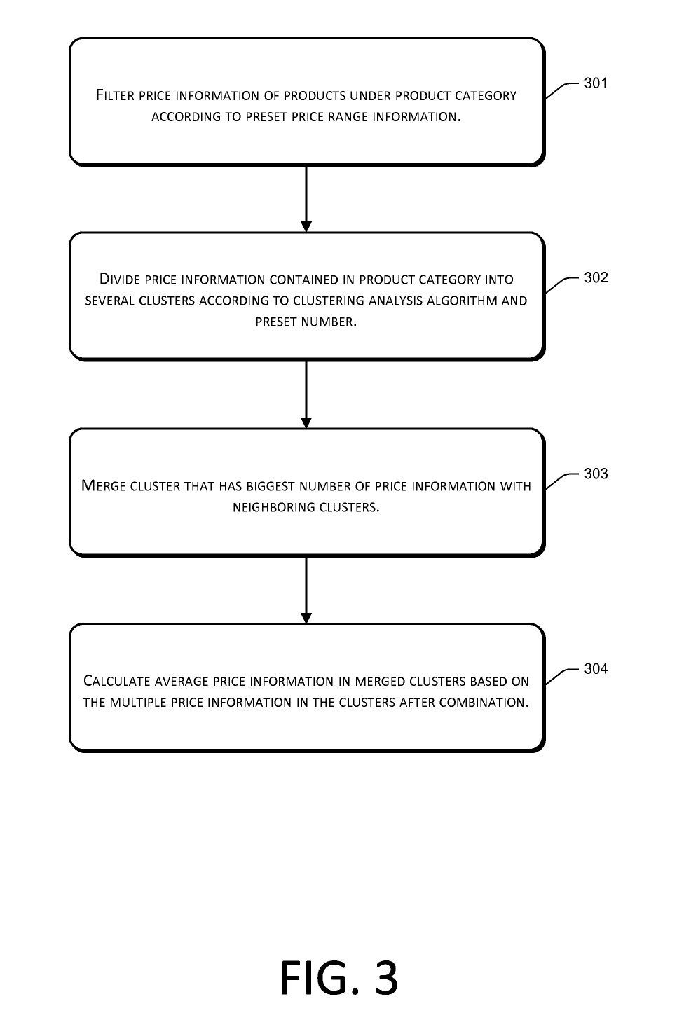

For example, FIG. 3 shows a flow diagram of applying clustering analysis algorithm to products under a product category to obtain the corresponding price information of each type of products.

At 301, the price information of the products under the product category is filtered according to preset price range information.

After the product category is obtained, the product attributes and sales attributes of the products in the product category are the same or substantially the same. However, it is not necessary that the price of each product need to be considered. Therefore, price information related to the products in the product category may be filtered. During filtering, the price ratio range of the labeled prices may be predefined for the products with labeled price information. For example, the upper limit may be set as 2 times the price, and the lower limit may be set as 0.5 times. Then the labeled price information is used to calculate the upper limit price and lower limit price in the labeled price range information. The price information is filtered by using the upper limit and lower limit price information.

For example, if the ratio of the number of products after filtering to the number of products before filtering is lower than a predefined threshold, such filtering can be deemed ineffective or invalid. For instance, such threshold may be set as 0.5. If after the filtering process, more than half the products under the product category have been filtered out, then such filtering process may not be an optimal process. Then the pre-filtered price information may still be used as the source data. If the ratio of the number of products after filtering to the number of products before filtering is not lower than a predefined threshold, such filtering may be deemed effective or valid. The filtered price information is used as the source data.

In addition, as products belong to a specific category such that Nokia N73 belongs to the mobile phone category and the ThinkPad X100 belongs to the notebook category, each category may be set a maximum price (price max) and a minimum price (price_min) to define a valid price information range. The price information that exceeds the defined price information range may be deemed as invalid.

Thus, when products under a product category do not have the labeled price information, the maximum and minimum price information of the products in the category may be predefined. Different values may be defined based on the categories. For example, the mobile phone category can have a minimum price of $100 and a maximum price of $10,000, and the notebook computer category may have a minimum price of $100, and a maximum price of $50,000. Such price range can be used to filter the product price information in the category.

At 302, the price information contained in the product category is divided into several clusters according to the clustering analysis algorithm and a preset number.

After the filtered product price information in the product category is obtained, the clustering analysis algorithm (such as the K-means algorithm) is performed on each product category to analyze the products into several, such as N, groups. The number N may be any integer. For instance, N may be 10. Based on the principles of the K-means algorithm, the elements in one cluster are neighboring elements, which means their price information are relatively close in this embodiment. For example, for one product category, the product prices in that product category are: 1, 102, 3, 4, 5, 100, 101, 104, and 8 respectively. Based on the clustering method in this embodiment, such price information can be divided into two clusters: [1, 3, 4, 5, 8] and [102, 100, 101, 104].

At 303, the cluster that has the biggest number of price information is merged with the neighboring clusters.

For example, after the clusters are obtained, the cluster that has the biggest number of products is found. To ensure that the chosen clusters have enough number of elements and have sufficient representation quality, the clusters neighboring the cluster that has the biggest number of products are merged until the number of products after combination is larger than a preset threshold. For instance, such threshold may be that the number of combined products occupies 5% of the product category.

At 304, the average price information in the merged clusters is calculated based on the multiple price information in the clusters after combination.

For example, the average price information may be based on the weighted average price information or the arithmetic average price information.

After the average price information of one product category is obtained, one or more product keywords of the product category may be associated with the average price information. Such association may be stored in a database for future inquiry use.

At 104, when the one or more product keywords are received, the price information of the product category that corresponds to the product keywords is displayed.

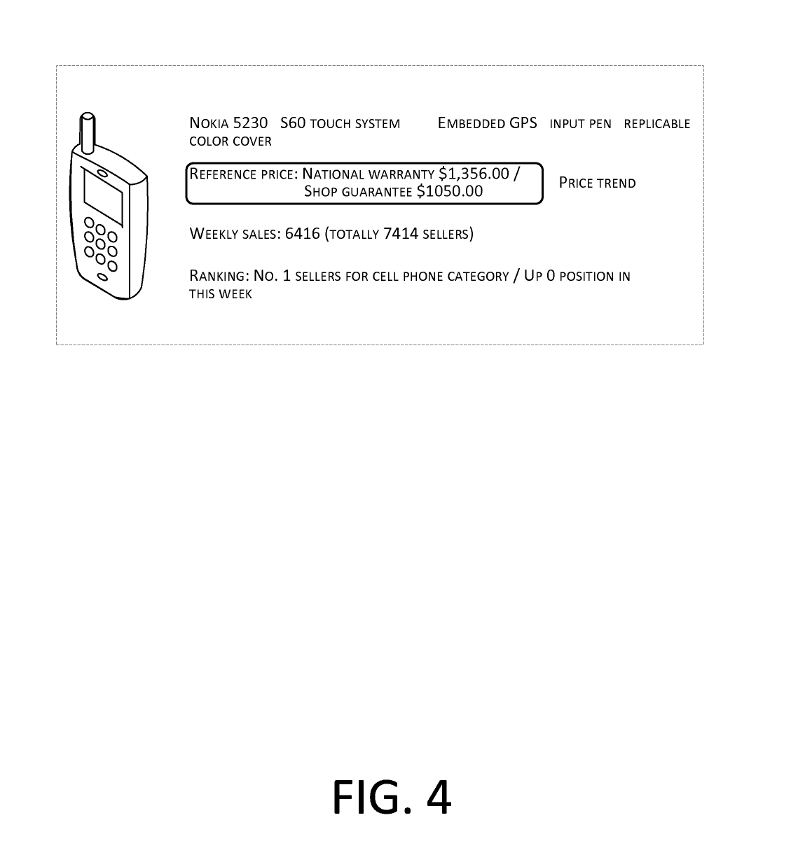

When the product keywords are received from the user's query, the average price information of the product category is searched according to the information of the product keywords and presented to the user. For example, the average price information in this example embodiment refers to the average price information of the product under a particular sales attribute. For instance, FIG. 4 shows an interface schematic diagram of average price information of an example product “Nokia 5230” under two sales attributes that are “Nationwide Guarantee” and “Shop Guarantee” respectively.

In this embodiment, the categorization of the products is based on both the fixed attribute and the sales attribute. As the sales attributes also has influence to the price information of the products, in one example embodiment, after the products are categorized based on the sales attribute, the clustering analysis method may be performed to calculate the average price information of the products that satisfy both the fixed attribute and the sales attribute. This may more reasonably reflect the price information of the product. Such method not only offers convenience to the user to look up price information, but also reduces the number of interaction operations and the repetitive inquiry operations between the user and the online transaction platform. Further such method also increases the operation performance of the servers of the online trading platform.

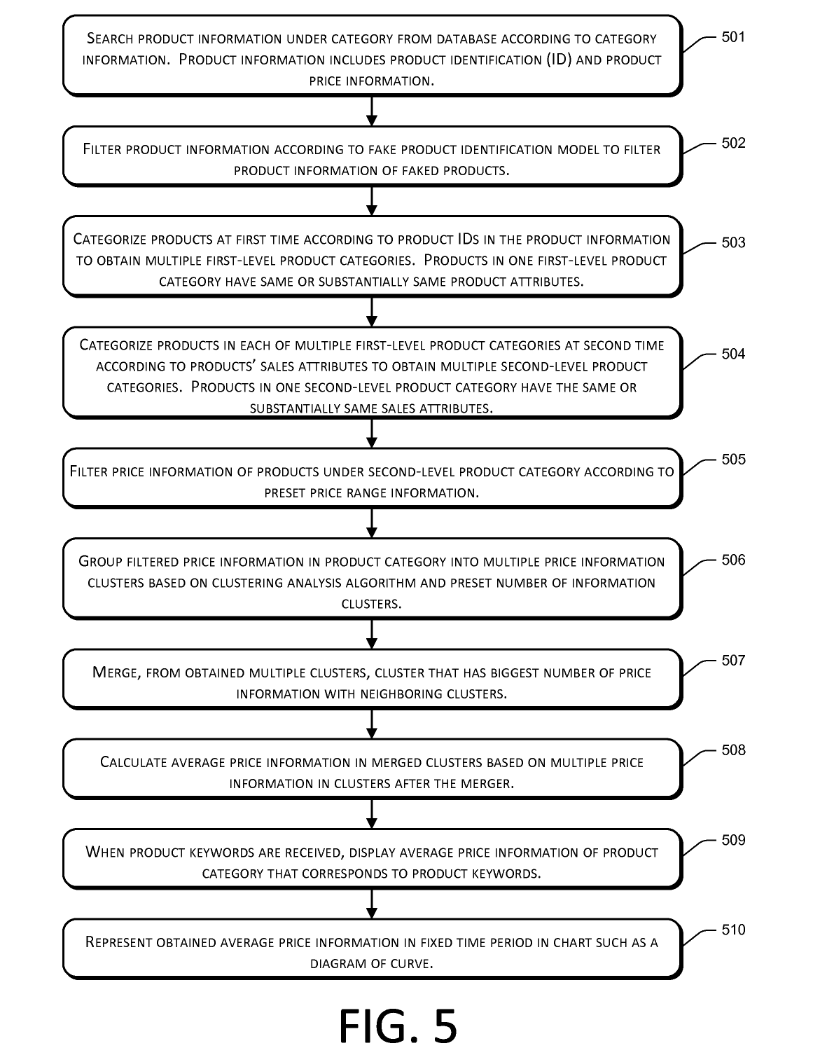

FIG. 5 shows a flow diagram of an example data processing method based on an online transaction platform in accordance with a second example embodiment.

At 501, product information under a category is searched from a database according to category information. The product information includes product identification (ID) and product price information.

At 502, the product information is filtered. For example, the product information may be filtered according to a fake product identification model to filter the product information of the faked products.

This example embodiment includes applying the filtering process to the obtained product information by using the fake product identification model. In a real application, some products may be off the shelf already, or some users maliciously publish false product information. Such product information is not suitable to be used to calculate the product price information. Thus, a trained fake product identification model may be used to filter the product information of the fake products.

The fake product identification model may also be updated periodically.

At 503, the products are categorized at a first time according to the product IDs in the product information to obtain multiple first-level product categories. The products in one first-level product category have the same or substantially same product attributes.

The product attributes refer to the inherent fixed attributes of the product. When the products are categorized at the first time according to the product attributes, the products are be categorized into multiple first-level product categories. The products in one product category have same or substantially same functions and characteristics. For example, the 300 ml Da Bao facial wash and the 100 ml Da Bao facial wash belong to the same first-level product category, but the Mary Kay soft facial cleanser belongs to another first-level product category.

At 504, the products in each of the multiple first-level product categories are categorized at a second time according to the products' sales attributes to obtain multiple second-level product categories. The products in one second-level product category have the same or substantially same sales attributes.

After the multiple first-level product categories are obtained, the products in the first-level product categories need to be further categorized at the second time based on the products' sales attributes. The products in each second-level product category have same or substantially same sales attributes. For example, a first user's product is the 300 ml Da Bao facial wash, a second user's product is the 100 ml Da Bao facial wash, and a third user's product is the 300 ml Da Bao facial wash. Although these three products belong to the same first-level product category, during the product categorization at the second time, the first user and the third user's products will belong to one second-level category, while the second user's product will belong to another second-level product category.

At 505, the price information of the products under the second-level product category is filtered according to preset price range information.

The preset price range information refers to the predefined price information upper limit and price information lower limit. The price information of the products in one second-level product category is filtered according to the preset price range information. The price information of the products that are within the preset price range are retained. The price information of the products that are outside the preset price range are excluded.

There can be different methods to perform the price filtering.

At A1, when the product in the product category does not have the labeled price information, the preset price range information of the category to which the product belongs is used for filtering purpose to obtain the price information set after filtering.

The labeled price information may be the manufacturer-labeled price information when the product was released by the manufacturer. If the product does not have the manufacturer-labeled price information, the product price information is filtered according to the preset price range information of the category. The price information after filtering all fall under the scope of the preset price range information.

At A2, when the product in the product category does have the labeled price information, a preset price ratio range information of the category to which the product belongs is used to obtain a preset labeled price range information. The present labeled price range information is used to filter the price information of the products in the product category.

When the products in the second-level category have the labeled price information, the preset price ratio range information is used to calculate the labeled price range information of the product in the product category. Further the labeled price range information is used to filter the price information of the products in the second-level product category.

At A3, based on the filtered product price information, the filtering strength of the filtering process is obtained to assess whether the filtering strength is lower than a predefined threshold. If the result is “Yes,” then the price information prior to the filtering is used. If the result is “No,” then the price information resulting from the filtering is used as the filtered price information set.

There may be various methods to measure the filtering strength. For example, the number of product price information after the filtering is divided by the number of product price information prior to the filtering to obtain the filtering strength. The filtering strength is then compared with a preset threshold. If the preset filtering strength is lower than the preset threshold such as 0.5, the filtering may be deemed invalid as more than half of the product price information has been filtered. If the filtering strength is higher than the preset threshold, the price information after the filtering is used as the filtered price information set.

At 506, the filtered price information in the product category is grouped into multiple price information clusters. Such grouping may be based on the clustering analysis algorithm and the preset number of information clusters.

The price information in the second-level category is grouped into several clusters according to the clustering analysis algorithm and the preset number of clusters. For example, the number of clusters is set as 10. There are also various clustering analysis algorithms. One example of clustering process is described below.

At B1, a center point of an initial cluster is selected according to an average value of the filtered price information set and the total preset number of clusters.

After the number of the price information clusters is obtained, the center point of the initial cluster is selected according to the average value of the filtered price information set and the total number of clusters. The purpose to select the initial cluster is to find the biggest cluster among the clusters. The biggest cluster is the one with the biggest number of price information. The biggest cluster information will be used as the basis to calculate the average price information of the product category under the current sales attribute.

At B2, an iterative clustering is applied to the price information set until a convergence is reached to obtain the required preset number of clusters based on the center point of the initial cluster and the clustering analysis algorithm.

For example, the K-means algorithm may be used in the iterative clustering until the convergence is reached to obtain the required preset number of clusters.

At B3, the clusters with a sufficient number of price information are selected from the cluster set as the finally obtained multiple clusters.

From the collection of the clusters, the clusters with a sufficiently big number of price information are selected as the finally obtained number of clusters to be used in the succeeding calculation of price information.

At 507, from the obtained multiple clusters, the cluster that has the biggest number of price information is merged with the neighboring clusters.

There are various merging methods. One example of merging method is described below.

At C1, the multiple clusters are sorted according to the center point value of each cluster. The biggest cluster with the biggest number of price information is also obtained from the multiple clusters.

When the clusters are merged, the biggest cluster with the biggest number of price information is searched according to the center point value of each cluster.

At C2, the neighboring clusters of the biggest cluster are merged according to the sorting order until the number of price information in the biggest cluster reaches a preset threshold.

According to the sorting order, the neighboring clusters of the biggest cluster are merged with the biggest cluster until the number of price information in the biggest cluster reaches a preset threshold.

At 508, the average price information in the merged clusters is calculated based on the multiple price information in the clusters after the merger.

There are various calculation methods. One example of calculation method is described below.

At D1, it is determined whether the product reference price information is set up. If the result is “Yes,” then operations at D2 are performed. If the result is “No,” then operations at D3 are performed.

At D2, if the number of the one or more clusters is more than 1, the one or more clusters are sorted based on the center point value of each cluster. The second cluster may be the finally obtained cluster. If the number of the price information in the second cluster is more than a ratio, such as 0.4 times, of the total number of price information in the finally obtained cluster, the average price information of the second cluster is the average price information of the product category.

At D3, the weighted average price information of the merged cluster is calculated based on the multiple price information in the cluster.

At 509, when one or more product keywords are received, the average price information of the product category that corresponds to the product keywords is displayed.

In addition, in another embodiment, the flow diagram may further include 510.

At 510, the obtained average price information in one or more fixed time periods is represented in a chart such as a diagram of curves.

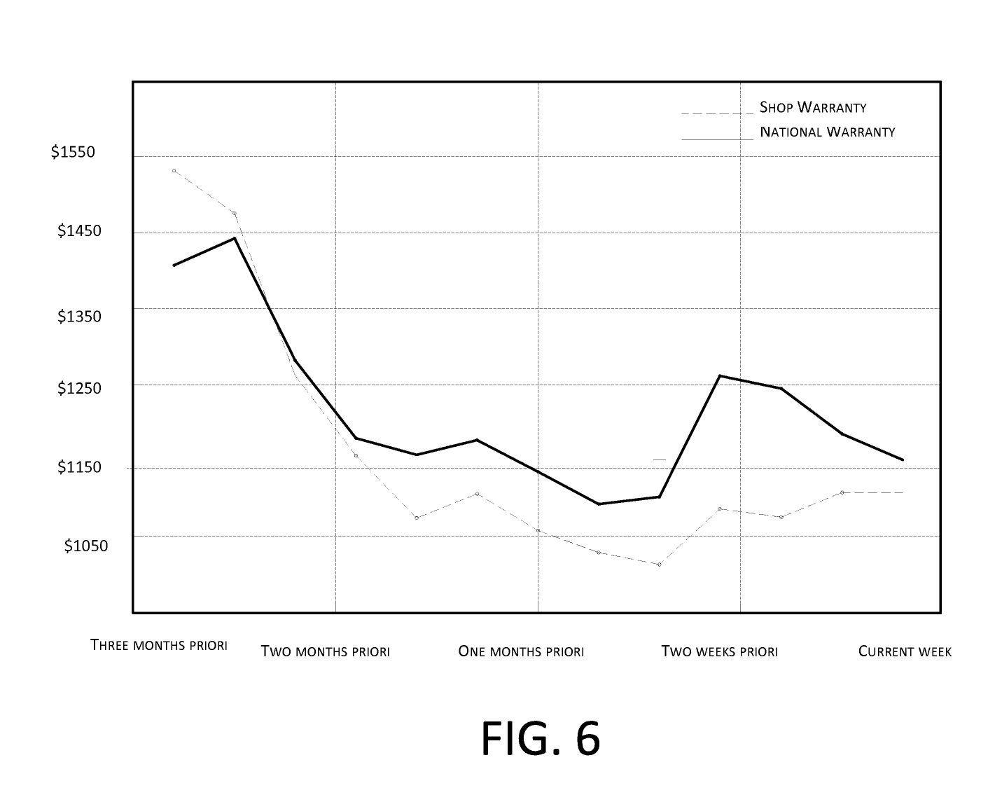

FIG. 6, corresponding to FIG. 4, shows a trend diagram of the price information of the example product “Nokia 5230” within the last 3 months.

The described operations in this embodiment not only improve the operational performance of the server but also display the price information of one product to the user by using a trend diagram. The applicable clustering analysis algorithm such as the K-means algorithm may further improve the accuracy of the calculation of the average price information. The accuracy of user's searching product price is further improved and thus the operational performance of the servers is further improved too.

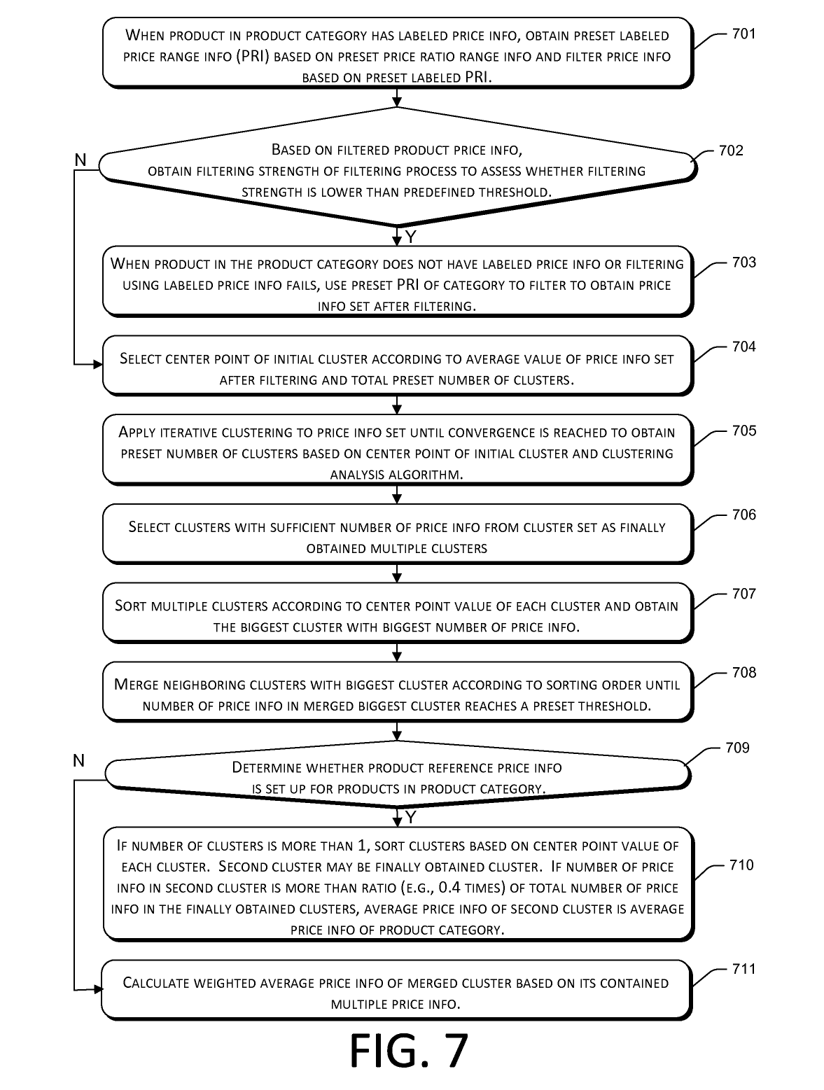

To provide further illustration and detailed examples, FIG. 7 shows a flow diagram of exemplary calculating product average price information of products under a second-level product category. The example below focuses on the calculation process of the average price information after the second-level category is obtained.

At 701, when the product in the product category does have the labeled price information, a preset price ratio range information of the category to which the product belongs is used to obtain a preset labeled price range information. The present labeled price range information is used to filter the price information of the products in the product category.

For example, for a certain product, there is n number of product items. Their price information set is represented as A={a₁, a₂, . . . , aₙ}. A represents the information set. aₙ represents price information of the n-th product item. For products with labeled price information, the price information may be filtered by using the labeled price information P_{ref}. The predefined price ratio range, for example, is represented as [S_{low}, S_{high}). The labeled price range, for example, is represented as [P_{low}, P_{high}) that may be calculated by using the labeled price information P_{ref}, where P_{low}=P_{ref}*S_{low}, P_{high}=P_{ref}*S_{high}. When the products in the product category have labeled price information, the labeled price range [P_{low}, P_{high}) can be used to filter the price information in order to obtain the filtered price information cluster represented as A_{ref}: A_{ref}={aᵢ|aᵢε[P_{low}, P_{high}], i=1 . . . n}. For instance, [S_{low}, S_{high}) may have a value of [0.5, 2).

At 702, based on the filtered product price information, the filtering strength of the filtering process is obtained to assess whether the filtering strength is lower than a predefined threshold. If the result is “Yes,” then the price information prior to the filtering is used and the operations at 702 will be performed. If the result is “No,” then the price information after the filtering is used as the filtered price information set and the operations at 704 will be performed.

For example, the filtering strength is calculated based on the obtained price information cluster, where the formula is: s=Size (A_{ref})/Size (A). If the filtering strength s is lower than a valid threshold S_{valid}, then the filtering process based on the labeled price information is considered a failure, and the price information before the filtering will be used In other words, A_{ref}=A. For instance, S_{valid} may have a value of 0.5

At 703, when the product in the product category does not have the labeled price information or the filtering using the labeled price information fails, the preset price range information of the category to which the product belongs is used for filtering purpose to obtain the price information set after filtering.

When the products in a product category do not have labeled price information, or the filtering process using the labeled price information is a failure, the predefined higher and lower limits of the price range information of the category where the products belong can be used to filter the data.

For example, for the category where the products belong, the higher and lower limits of the price range are represented as [CP_{low}, CP_{high}], where CP_{low} represents the lower limit of the price, and CP_{high} represents the higher limit of the price. The higher and lower limits of the prices are used to determine the effective price range for the products under the category. If the price information of the products exceeds the price range, such price information may be deemed invalid price information. The finally obtained price information set is represented as A_{ref}={aᵢ|aᵢε[CP_{low}, CP_{high}], i=1 . . . n}.

At 704, a center point of an initial cluster is selected according to an average value of the price information set after filtering and the total preset number of clusters.

For example, in the actual calculation process, the center point of the initial cluster will be selected based on the average value in the price information cluster. If m is defined as the total number of preset clusters, the location of the center point is represented as:

C={cᵢ|Center(cᵢ)=2i*E(A_{ref})/m,i=1; . . . m}

At 705, an iterative clustering is applied to the price information set until a convergence is reached to obtain the required preset number of clusters based on the center point of the initial cluster and the clustering analysis algorithm.

For example, in actual application, the iterative clustering may be done by using the K-MEANS calculation method, and during convergence, a collection of clusters represented as Cᵣₑₛ can be obtained. In this operation, for example, the criteria for assessing the iteration convergence may be that the sum of the square of the distance between the two center points resulting from the two iterations is smaller than a threshold t_{dis}. For instance, after undergoing K number of iterations, the center points of the two closest center point clusters, Cₖ₋₁, Cₖ, are obtained. After it is determined that the following criteria

$${\sum }_{i = 1}^{m} {( {c}_{k - 1 , i} - {c}_{k , i} )}^{2} < {t}_{dis} , {c}_{k - 1 , i} ∈ {C}_{k - 1} , {c}_{k , i} ∈ {C}_{k}$$

is satisfied, Cₖ becomes the collection of the cluster Cᵣₑₛ. In the above criteria, for example, t_{dis}=0.00001

At 706, the clusters with a sufficient number of price information are selected from the cluster set as the finally obtained multiple clusters.

The clusters with the sufficiently large number of price information are to be retained, which is represented as Cₖₑₑₚ={cₖ|Count(cₖ)>tₘᵢₙ*Σᵢ₌₁^{m}Count(cᵢ),cₖδC}.

For example, the threshold tₘᵢₙ may be defined as 0.05.

At 707, the multiple clusters are sorted according to the center point value of each cluster. The biggest cluster with the biggest number of price information is also obtained from the multiple clusters.

The kept multiple clusters are sorted based on the center point values to find the cluster C_{b} with the biggest number of elements.

At 708, the neighboring clusters of the biggest cluster are merged according to the sorting order until the number of price information in the biggest cluster reaches a preset threshold.

For example, the neighboring clusters on the left and right sides of the biggest cluster is merged with the biggest cluster until a ratio of the total number of price information in the merged biggest cluster is higher than the threshold t_{c1}. In other words, the following criterion is satisfied:

Cₘₐᵢₙ={cₖ|Σₖ₌₁^{r}Count(cₖ)>t_{c1}*Σᵢ₌₁^{m}Count(cᵢ);kε[1,r],bε[1,r]}.

For instance, the threshold t_{c1} may be defined as 0.05.

At 709, it is determined whether the product reference price information is set up for the products in the product category. If the result is “Yes,” then operations at 710 are performed. If the result is “No,” then operations at 711 are performed.

At 710, if the number of the one or more clusters is more than 1, the one or more clusters are sorted based on the center point value of each cluster. For example, the second cluster may be the finally obtained cluster. If the number of the price information in the second cluster is more than a ratio, such as 0.4 times, of the total number of price information in the finally obtained clusters, the average price information of the second cluster is the average price information of the product category.

For example, if the reference price information has been established for the products in the product category, the number of clusters in Cₖₑₑₚ is larger than 1, the collection of clusters are sorted based on the number of price information in the clusters. If the second cluster after the sorting belongs to Cₖₑₑₚ, and the number of price information in the second cluster is 0.4 times greater than the total number of price information in the collection of clusters, then the average price information of the second cluster is used as the reference price of the product category.

At 711, the weighted average price information of the merged cluster is calculated based on its contained multiple price information.

For example, the clusters in Cₘₐᵢₙ are used to calculate the weighted average:

$$Price = \frac{{\sum }_{i = 1}^{r} {\sum }_{j = 1}^{Count ( {c}_{i} )} {a}_{i , j} * ( \frac{m - \vert i - b \vert}{m} )}{{\sum }_{i = 1}^{r} Count ( {c}_{i} ) * ( \frac{m - \vert i - b \vert}{m} )} {C}_{main}$$

Here, l and r, refer to the left border and right border respectively of the finally retained cluster after the clusters are sorted in ascending order based on the center point values. Count(cᵢ) refers to the total number of elements in the cluster. a_{i,j} refers to the cluster element, which means price information in this example. b refers to the central cluster with the largest number of elements. In this example, m=10. For example, if after clustering, the sixth cluster is found to have the largest number of elements, the neighboring clusters on the left and right of the sixth clusters are merged with the sixth cluster until the number of price information in the merged cluster is sufficiently large. For example, assuming that the position of the cluster at the left border is 3, and the position of the cluster at the right border is 8, then these values can be substituted into the above formula to calculate the average price information of the current product category under its sales attributes.

The calculated average price information in this example is the product's average price information under its sales attributes. In the example, the calculated product average price information combines the product's labeled price information and the transaction price information on the online transaction platform. The application of the clustering analysis method to the product price information can make the price information realistically reflecting the product's reasonable price information. In addition, the filtering of fake product information also improves the reasonableness of the calculated product price.

The above example methods, for purpose of convenience, are described as a series of operations. One of ordinary in the art would appreciate that this disclosure may not be limited to the sequence of the described operations. According to the present disclosure, the operations may take other sequences. Some or all of the operations may also occur simultaneously or substantially simultaneously. One of ordinary skill in the art would also appreciate that some operations or modules are not necessary for some embodiments.

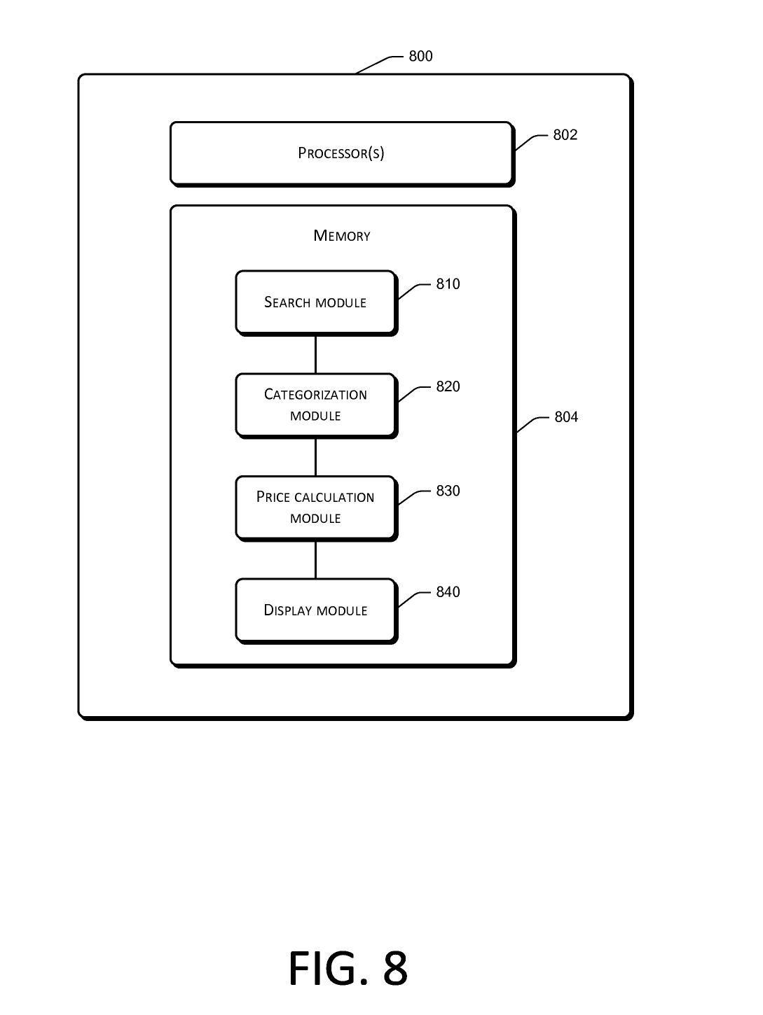

Corresponding to the data processing method based on the online transaction platform in the first example method embodiment, FIG. 8 shows a structured diagram of a first example data processing device 800 based on the online transaction platform in the first example embodiment.

In one embodiment, the device 800 may include, but is not limited to, one or more processors 802 and memory 804. The memory 804 may include computer-readable media in the form of volatile memory, such as random-access memory (RAM) and/or non-volatile memory, such as read only memory (ROM) or flash RAM. The memory 504 is an example of computer-readable media.

Computer-readable media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. As defined herein, computer-readable media does not include transitory media such as modulated data signals and carrier waves.

The memory 804 may store therein program units or modules and program data. In one embodiment, the modules may include a search module 810, a categorization module 820, a price calculation module 830, and a display module 840.

These modules may therefore be implemented in software that can be executed by the one or more processors 802. In other implementations, the modules may be implemented in firmware, hardware, software, or a combination thereof.

The search module 810 searches product information under a category from a database according to category information. The products information includes product identifications (IDs) and product price information.

The categorization module 820 categorizes the products according to the product attributes and sale attributes to obtain multiple product categories. The products under the same product category have same or substantially similar product attributes and sale attributes. The sale attributes are attributes other than the product attributes that affect the product prices.

The price calculation module 830 applies one or more calculation analysis algorithms to the products under each category respectively to obtain price information that corresponds to each product category. The one or more calculation algorithms include a clustering algorithm. The price information refers to price information of the products under their corresponding sale attributes.

The display module 840, when one or more product keywords are received, displays the price information of the product category that corresponds to the product keywords.

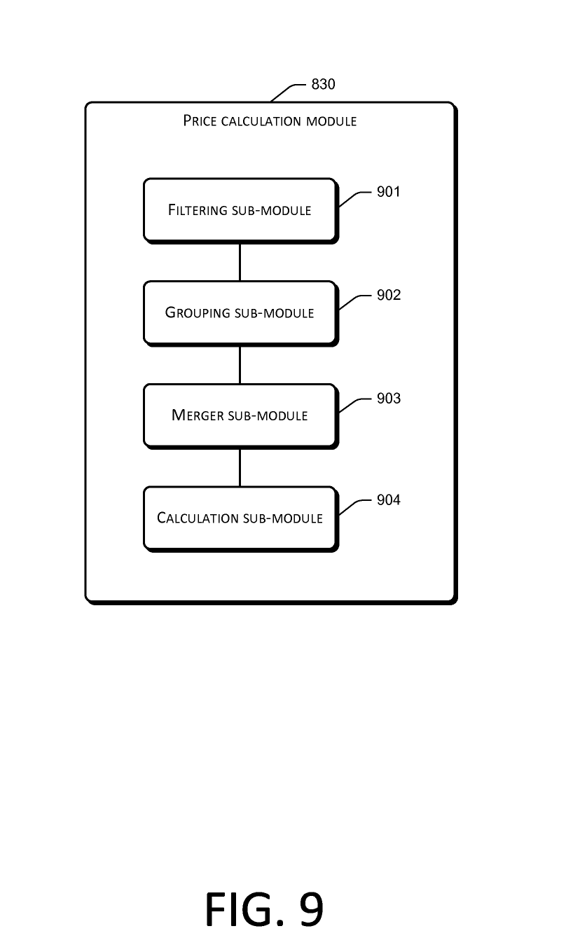

As shown in FIG. 9, the price calculation module 830 may further include a filtering sub-model 901, a grouping sub-module 902, a merger sub-module 903, and a calculation sub-module 904.

The filtering sub-module 901 filters the price information of the products under one product category according to preset price range information.

The filtering sub-module 901 may be configured with many methods and/or embodiments to filter the price information. For example, the filtering sub-module 901 may also include a first filtering sub-module, a second filtering sub-module, and a determination sub-module.

The first filtering sub-module, when the product in the product category does not have the labeled price information, filters the price information according to the preset price range information of the category to which the product belongs to obtain the price information set after filtering.

The second filtering sub-module, when the product in the product category does have the labeled price information, obtains preset labeled price range information according to the preset price ratio range information of the category to which the product belongs to, and filters the price information by using the present labeled price range information.

The determination sub-module, based on the filtered product price information, obtains the filtering strength of the filtering process and assesses whether the filtering strength is lower than a predefined threshold. If the result is “Yes,” then the price information prior to the filtering is used. If the result is “No,” then the price information resulting from the filtering is used as the filtered price information set.

The grouping sub-module 902 groups the filtered price information in the product category into multiple price information clusters. Such grouping may be based on the clustering analysis algorithm and the preset number of information clusters.

The grouping sub-module 902 may be configured with many methods and/or embodiments to group the filtered price information. For example, the grouping sub-module 902 may further include a selection sub-module, a clustering sub-module, and a cluster obtaining sub-module.

The selection sub-module selects a center point of an initial cluster according to an average value of the filtered price information set and the total preset number of clusters.

The clustering sub-module applies an iterative clustering to the price information set until a convergence is reached to obtain the required preset number of clusters based on the center point of the initial cluster and the clustering analysis algorithm.

The cluster obtaining sub-module selects clusters with a sufficient number of price information from the cluster set as the finally obtained multiple clusters.

The merger sub-module 903, from the obtained multiple clusters, merges the cluster that has the biggest number of price information with the neighboring clusters.

The merger sub-module 903 may be configured with many methods and/or embodiments to merge the clusters. For example, the merger sub-module 903 may further include a sorting sub-module and a merging sub-module.

The sorting sub-module sorts the multiple clusters according to the center point value of each cluster and obtains the biggest cluster with the biggest number of price information from the multiple clusters.

The merging sub-module merges the neighboring clusters of the biggest cluster with the biggest cluster according to the sorting order until the number of price information in the biggest cluster reaches a preset threshold.

The calculation sub-module 904 calculates the average price information in the merged clusters based on the multiple price information in the clusters after the merger.

The calculation sub-module 904 may be configured with many methods and/or embodiments to calculate the average price information.

For example, the calculation sub-module 904 may determine whether the product reference price information is set up. If the result is “Yes,” and if the number of the one or more clusters is more than 1, the one or more clusters are sorted based on the center point value of each cluster. The second cluster may be the finally obtained cluster. If the number of the price information in the second cluster is more than a ratio, such as 0.4 times, of the total number of price information in the finally obtained cluster, the average price information of the second cluster is the average price information of the product category.

If the result is “No,” then the weighted average price information of the merged cluster is calculated based on the multiple price information in the cluster.

The device and/or one or more modules in the exemplary embodiment can be integrated into the online transaction platform server, or can be set up as a stand-alone entity that is connected to the online transaction platform server. When the method in the present disclosure is implemented through software, it can be included as an add-on functionality in the online transaction platform server, and can also be implemented as an independent program storing on computer-readable media. The present disclosure does not set a limit on the form of implementation for the method, device, and/or modules.

The device disclosed in the exemplary embodiment may more accurately and reasonably reflect the price information of the product. This will simplify the user's process of searching for price information, and meanwhile it will decrease the user's frequency of interaction with the online transaction platform server and the repetitive queries, thereby improving the online transaction platform server's operational function.

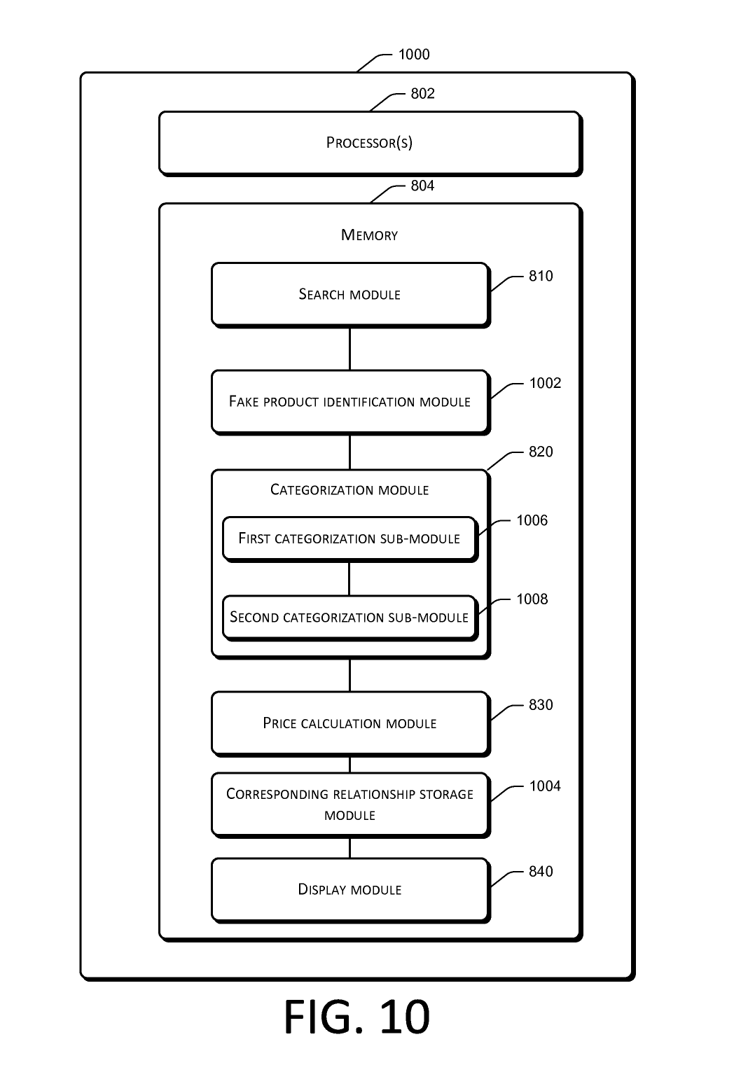

Corresponding to the data processing method based on the online transaction platform in the second example method embodiment, FIG. 10 shows a structured diagram of a second example data processing device 1000 based on the online transaction platform in the first example embodiment.

In one embodiment, the device 1000 may include, but is not limited to, one or more processors 802 and memory 804.

The memory 804 may store therein program units or modules and program data. In one embodiment, the modules may include a search module 810, a fake product identification model module 1002, a categorization module 820, a price calculation module 830, a corresponding relationship storage module 1004, and a display module 840.

These modules may therefore be implemented in software that can be executed by the one or more processors 802. In other implementations, the modules may be implemented in firmware, hardware, software, or a combination thereof.

The search module 810 searches product information under a category from a database according to category information. The products information includes product identifications (IDs) and product price information.

The fake product identification model module 1002 filters the products by using one or more fake product identification models to filter the production information of the fake products.

The categorization module 820 may further include a first categorization sub-module 1006 and a second categorization sub-module 1008.

The first categorization sub-module 1006 categories the products at a first time according to the product ID in the product information to obtain multiple first-level product categories. The products in one first-level product category have the same or substantially same product attributes.

The second categorization sub-module 1008 categorizes the products in each of the multiple first-level product categories at a second time according to the products' sales attributes to obtain multiple second-level product categories. The products in one second-level product category have the same or substantially same sales attributes.

The price calculation module 830 applies one or more calculation analysis algorithms to the products under each category respectively to obtain price information that corresponds to each product category. The one or more calculation algorithms include a clustering algorithm.

The corresponding relationship storage module 1004 stores the corresponding relationships between the product information and the calculated price information.

The display module 840, when one or more product keywords are received, displays the average price information of the product category that corresponds to the product keywords.

In addition, the present disclosure also provides an online transaction platform server. The one or more processors and/or computer-readable media of the server may be integrated with any part of the device or any device as disclosed in the present disclosure.

The various exemplary embodiments are progressively described in the present disclosure. Same or similar portions of the exemplary embodiments can be mutually referenced. Each exemplary embodiment has a different focus than other exemplary embodiments. In particular, the exemplary system embodiments are described in a relatively simple manner because of its fundamental correspondence with the exemplary method embodiments. Details thereof can be referred to related portions of the exemplary method embodiments.

Finally, it is noted that any relational terms such as “first” and “second” in the present disclosure are only meant to distinguish one entity from another entity or one operation from another operation, but not necessarily request or imply existence of any real-world relationship or ordering between these entities or operations. Moreover, it is intended that terms such as “include”, “have” or any other variants mean non-exclusively “comprising”. Therefore, processes, methods, articles or devices which individually include a collection of features may include not only those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

The clustering methods and systems provided by in the present disclosure have been described in details above. The above exemplary embodiments are employed to illustrate the concept and implementation of the present disclosure. The exemplary embodiments are provided to facilitate understanding of the methods and respective core concepts of the present disclosure. Based on the concepts of this disclosure, one of ordinary skill in the art may make modifications to the practical implementation and application scopes. In conclusion, the content of the present disclosure shall not be interpreted as limitations of this disclosure.

What is claimed is:

1. A method for data processing based on an online transaction platform, performed by one or more processors configured with computer-executable instructions, the method comprising:
searching product information of one or more products under one or more categories from a database according to category information of the one or more categories;
categorizing the products according to product attributes and sale attributes of the products to obtain multiple product categories; and
applying a clustering analysis algorithms to products under each product category respectively to calculate price information that corresponds to each product category.

2. The method as recited in claim 1, further comprising when one or more product keywords are received, displaying the price information of a product category that corresponds to the one or more product keywords.

3. The method as recited in claim 1, wherein the product information includes product identification (ID) and product price information.

4. The method as recited in claim 1, wherein the products under one product category have same or substantially similar product attributes and sale attributes.

5. The method as recited in claim 4, wherein the sale attributes are attributes other than product attributes that affect product prices.

6. The method as recited in claim 1, wherein the price information includes price information of the products under their corresponding sale attributes.

7. The method as recited in claim 1, further comprising prior to categorizing the products, filtering the product information by using a fake product identification model to filter product information of faked products.

8. The method as recited in claim 1, further comprising after applying the clustering analysis algorithms to products under each category respectively to obtain price information that corresponds to each product category, storing corresponding relationships between the product information and the obtained price information.

9. The method as recited in claim 1, wherein categorizing the products according to product attributes and sale attributes of the products to obtain multiple product categories comprises:
categorizing the products at a first time according to product IDs in the product information to obtain multiple first-level product categories, products in one first-level product category having same or substantially same product attributes; and
respectively categorizing products in each of multiple first-level product categories at a second time according to the products' sales attributes to obtain multiple second-level product categories, products in one second-level product category having same or substantially same sales attributes.

10. The method as recited in claim 1, wherein applying the clustering analysis algorithms to products under each category respectively to calculate price information that corresponds to each product category comprises:
filtering price information of products under a product category according to preset price range information;
grouping filtered price information of the product category into multiple price information clusters based on the clustering analysis algorithm and a preset number of information clusters;
merging, from obtained multiple clusters, a cluster that has a biggest number of price information with neighboring clusters; and
calculating average price information in the merged clusters based on multiple price information in clusters after the merger.

11. The method as recited in claim 10, wherein the filtering price information of products under the product category according to preset price range information comprises:
when products in the product category do not have labeled price information, using preset price range information of the category to filter to obtain a price information set after filtering;
when the products in the product category have labeled price information, obtaining a preset labeled price range information based on preset price ratio range information, and filtering the price information based on the preset labeled price range information;
based on the filtered product price information, obtaining filtering strength of the filtering process to assess whether a filtering strength is lower than a predefined threshold;
if an assessment result is positive, using the price information before the filtering; and
if the assessment result is negative, using the price information after the filtering.

12. The method as recited in claim 10, wherein grouping the filtered price information in product category into multiple price information clusters based on the clustering analysis algorithm and the preset number of information clusters comprises:
selecting a center point of an initial cluster according to an average value of the price information set after filtering and the preset number of clusters;
applying an iterative clustering to the price information set until a convergence is reached to obtain the required preset number of clusters based on the center point of the initial cluster and the clustering analysis algorithm; and
selecting clusters with sufficient number of price information from the multiple clusters as finally obtained multiple clusters.

13. The method as recited in claim 10, wherein merging, from obtained multiple clusters, the cluster that has the biggest number of price information with neighboring clusters comprises:
sorting the multiple clusters according to the center point value of each cluster and obtaining the biggest cluster with the biggest number of price information; and
merging neighboring clusters with the biggest cluster according to a sorting order until a number of price information in the merged biggest cluster reaches a preset threshold.

14. The method as recited in claim 10, wherein calculating the average price information in the merged clusters based on multiple price information in clusters after the merger comprises:
determining whether product reference price information is set up for the products in the product category;
if a result of the determining is positive, and if a number of clusters is more than one,
sorting the clusters based on a center point value of each cluster; and
when a second cluster is obtained and the number of price information in the second cluster is more than a preset ratio of a total number of price information in the finally obtained clusters, using average price information of the second cluster as the average price information of the product category; and
if the result of the determining is negative, calculating weighted average price information of merged cluster based on its contained multiple price information.

15. A device for data processing based on an online transaction platform, the device comprising:
one or more processors communicatively coupled to memory, the memory storing the following modules, which are executable on the one or more processors:
a search module that searches product information of one or more products under one or more categories from a database according to category information, the product information including product identification (ID) and product price information;
a categorization module that categorizes the products according to the product attributes and sale attributes to obtain multiple product categories, the products under one product category having same or substantially similar product attributes and sale attributes, the sale attributes being attributes other than the product attributes that affect the product prices;
a price calculation module that applies one or more calculation analysis algorithms to the products under each product category respectively to obtain price information that corresponds to each product category, the one or more calculation algorithms including a clustering algorithm, the price information referring to price information of the products under their corresponding sale attributes; and
a display module that, when one or more product keywords are received, displays the price information of the product category that corresponds to the product keywords.

16. The device as recited in claim 15, the price calculation module comprising:
a filtering sub-module that filters the price information of the products under one product category according to preset price range information;
a grouping sub-module that groups the filtered price information in the product category into multiple price information clusters based on the clustering analysis algorithm and the preset number of information clusters;
a merger sub-module that, from the obtained multiple clusters, merges a cluster that has a biggest number of price information with its neighboring clusters; and
a calculation sub-module that calculates average price information in the merged clusters based on multiple price information contained in the clusters after the merger.

17. The device as recited in claim 16, wherein the merger sub-module comprising:
a sorting sub-module that sorts the multiple clusters according to a center point value of each cluster and obtains the biggest cluster with the biggest number of price information from the multiple clusters; and
a merging sub-module that merges the neighboring clusters of the biggest cluster with the biggest cluster according to the sorting order until the number of price information in the biggest cluster reaches a preset threshold.

18. The device as recited in claim 15, further comprising a fake product identification model module that filters the products by using one or more fake product identification models to filter production information of fake products.

19. The device as recited in claim 15, further comprising a corresponding relationship storage module that stores corresponding relationships between the product information and the calculated price information.

20. One or more computer-readable media comprising computer-executable instructions executable by one or more processors that, when executed by the one or more processors, cause the one or more processors to perform operations comprising:
searching product information of one or more products under one or more categories from a database according to category information of the one or more categories, the product information including product identification (ID) and product price information, products under one product category having same or substantially similar product attributes and sale attributes, the sale attributes are attributes other than product attributes that affect product prices, the price information including price information of the products under their corresponding sale attributes;
using a fake product identification model to filter product information of faked products;
categorizing the products after the filtering according to product attributes and sale attributes of the products to obtain multiple product categories, the categorizing including:
categorizing the products at a first time according to product IDs in the product information to obtain multiple first-level product categories, products in one first-level product category having same or substantially same product attributes; and
respectively categorizing products in each of multiple first-level product categories at a second time according to products' sales attributes to obtain multiple second-level product categories, products in one second-level product category having same or substantially same sales attributes;
applying a clustering analysis algorithms to products under each category respectively to calculate price information that corresponds to each product category; and
when one or more product keywords are received, displaying the price information of a product category that corresponds to the one or more product keywords.
